(19) United States
(12) Patent Application Publication
(10) Pub. No.: US 2025/0129669 A1
(43) Pub. Date: Apr. 24, 2025

(54) ENERGY ABSORBER ASSEMBLY FOR USE WITH A LADDER SAFETY SYSTEM

(71) Applicant: Pure Safety Group, Inc., Pasadena, TX (US)

(72) Inventor: Judd J. Perner, Missouri, TX (US)

(73) Assignee: Pure Safety Group, Inc., Pasadena, TX (US)

(21) Appl. No.: 18/915,910

(22) Filed: Oct. 15, 2024

Related U.S. Application Data
(60) Provisional application No. 63/544,857, filed on Oct. 19, 2023.
(60) Provisional application No. 63/544,856, filed on Oct. 19, 2023.

(51) Int. Cl. E06C 7/18

(52) U.S. Cl. CPC E06C 7/186

(57) ABSTRACT

An energy absorber assembly for use with a ladder safety system operatively connected to a ladder comprises a cable connector, an energy absorber, and a bottom. The cable connector is configured and arranged to be operatively connected to a portion of a cable. The energy absorber is operatively connected to the cable connector and is configured and arranged to move from an expanded position toward a compressed position. The bottom is fixed relative to the ladder and is configured and arranged to support the energy absorber.

### CROSS-REFERENCE TO RELATED APPLICATIONS

This application claims the benefit of U.S. Provisional patent application Ser. No. 63/544,857, filed Oct. 19, 2023, and U.S. Provisional patent application Ser. No. 63/544,856, filed Oct. 19, 2023, which are incorporated herein by reference in their entireties.

### BACKGROUND

Fall protection equipment is commonly used to reduce a likelihood of a fall and/or serious injuries associated with a fall, particularly by users who perform tasks at heights or are at risk of falling. Generally, lifelines or lanyards typically interconnect anchorage structures and safety harnesses donned by users. The lifelines or lanyards allow the users to move and perform tasks while being connected to the anchorage structures. Should a user fall, the fall protection equipment limits the distance the user falls.

A user climbing up and down a vertical structure, such as a ladder or a tower, typically utilizes a vertical fall arrest system (e.g., a ladder safety system) as an anchorage structure. An example vertical fall arrest system includes a rope or a cable along which a rope or cable sleeve travels as the user moves along the vertical structure. The rope or cable is operatively connected to the vertical structure with a connector assembly. Should a fall occur, the sleeve locks onto the rope or cable and preferably there is an energy absorber assembly operatively connected to the rope or cable.

For the reasons stated above and for other reasons stated below, which will become apparent to those skilled in the art upon reading and understanding the present specification, there is a need in the art for an energy absorber assembly for use with a ladder safety system.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, an energy absorber assembly for use with a ladder safety system operatively connected to a ladder comprises a cable connector, an energy absorber, and a bottom. The cable connector is configured and arranged to be operatively connected to a portion of a cable. The energy absorber is operatively connected to the cable connector and is configured and arranged to move from an expanded position toward a compressed position. The bottom is fixed relative to the ladder and is configured and arranged to support the energy absorber.

In one embodiment, a connector assembly for use with a ladder safety system comprises a bracket base, a connector base, and a fastener. The bracket base includes a bracket base slot, and the connector base has a bore configured and arranged to slidably receive the bracket base. A first side of the connector base includes a connector base slot, and the connector base slot is selectively aligned with the bracket base slot. A second side is opposite the first side. The fastener is pivotally connected to the second side of the connector base, wherein the fastener pivots from a receiving position to an engaging position. The receiving position is when the fastener extends away from the bracket base, and the engaging position is when the fastener extends through the bracket base slot, the bore, and the connector base slot.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1 is a front perspective view of an embodiment ladder safety system, including an embodiment energy absorber assembly and an embodiment connector assembly, constructed in accordance with the principles of the present invention and operatively connected to a ladder;

FIG. 2 is a partially exploded front perspective view of an embodiment top bracket assembly of the ladder safety system shown in FIG. 1;

FIG. 2A is an exploded front perspective view of an embodiment connector of the top bracket assembly shown in FIG. 2;

FIG. 3 is a partially exploded front view of the top bracket assembly shown in FIG. 2;

FIG. 4 is a partially exploded right side view of the top bracket assembly shown in FIG. 2;

FIG. 5 is a partially exploded rear view of the top bracket assembly shown in FIG. 2;

FIG. 6 is a partially exploded front perspective view of the top bracket assembly shown in FIG. 2 in a disconnected connector position for connecting to the ladder;

FIG. 7 is a partially exploded front perspective view of the top bracket assembly shown in FIG. 2 in a partially disconnected connector position for connecting to the ladder;

FIG. 8 is a front view of the top bracket assembly shown in FIG. 2 connected to the ladder;

FIG. 9 is a rear view of the top bracket assembly shown in FIG. 2 connected to the ladder;

FIG. 10 is a partially exploded front perspective view of the top bracket assembly connected to the ladder and an embodiment energy absorber assembly shown in FIG. 1;

FIG. 11 is an exploded front perspective view of the energy absorber assembly shown in FIG. 10;

FIG. 12 is a partially exploded front perspective view of the top bracket assembly connected to the ladder and the energy absorber assembly shown in FIG. 10 being inserted into a housing of the top bracket assembly;

FIG. 13 is a front perspective view of the energy absorber assembly operatively connected to the top bracket assembly, shown in FIG. 10, with the housing removed;

FIG. 14 is a front perspective view of the energy absorber assembly operatively connected to the top bracket assembly, shown in FIG. 10, with the housing removed;

FIG. 15 is a front perspective view of the energy absorber assembly in an expanded position;

FIG. 16 is a front perspective view of the energy absorber assembly operatively connected to the top bracket assembly, shown in FIG. 10, with the housing removed, in a compressed position;

FIG. 17 is a front perspective view of the energy absorber assembly operatively connected to the top bracket assembly, shown in FIG. 10, with the housing removed, in a compressed position;

FIG. 18 is a front perspective view of the energy absorber assembly in a compressed position;

FIG. 19 is a partially exploded front perspective view of an embodiment bottom bracket assembly of the ladder safety system shown in FIG. 1;

FIG. 20 is a partially exploded front perspective view of the bottom bracket assembly shown in FIG. 19 in a disconnected connector position for connecting to the ladder;

FIG. 21 is a partially exploded front perspective view of the bottom bracket assembly shown in FIG. 19 in a partially disconnected connector position for connecting to the ladder;

FIG. 22 is a front perspective view of the bottom bracket assembly shown in FIG. 19 in a connected connector position operatively connected to the ladder;

FIG. 23 is a front perspective view of the bottom bracket assembly shown in FIG. 19 in a connected connector position operatively connected to the ladder and operatively connected to a cable in an un-tensioned position; and

FIG. 24 is a front perspective view of the bottom bracket assembly shown in FIG. 19 in a connected connector position operatively connected to the ladder and operatively connected to a cable in a tensioned position.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

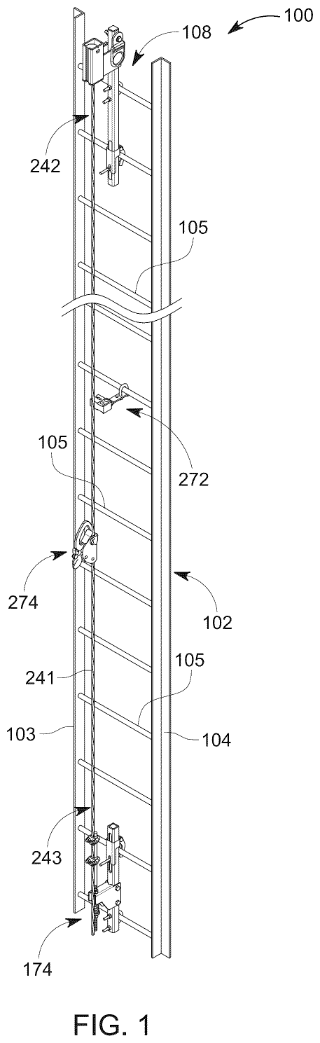

An example ladder safety system 100 is shown in FIG. 1 and includes a top bracket 108, a bottom bracket 108, and an optional intermediate support 272. The ladder safety system 100 can be connected to a vertical structure such as a ladder or similar support structure. An example ladder 102, shown in FIG. 1, includes a first side rail 103 and a second side rail 104 interconnected with a plurality of rungs 105. The top bracket 108 is operatively connected to a rung 105 proximate a top of the ladder 102, and the bottom bracket 174 is operatively connected to a rung 105 proximate a bottom of the ladder 102. A cable assembly 240 is operatively connected to the top and bottom brackets 108 and 174 and tensioned with a tension assembly 190, which in this example is operatively connected to the bottom bracket 174. If the length of the cable 241 is relatively long, the intermediate support 272 could be used proximate an intermediate position between the top and bottom brackets 108 and 174. An energy absorber 254 is preferably incorporated into the cable assembly 240.

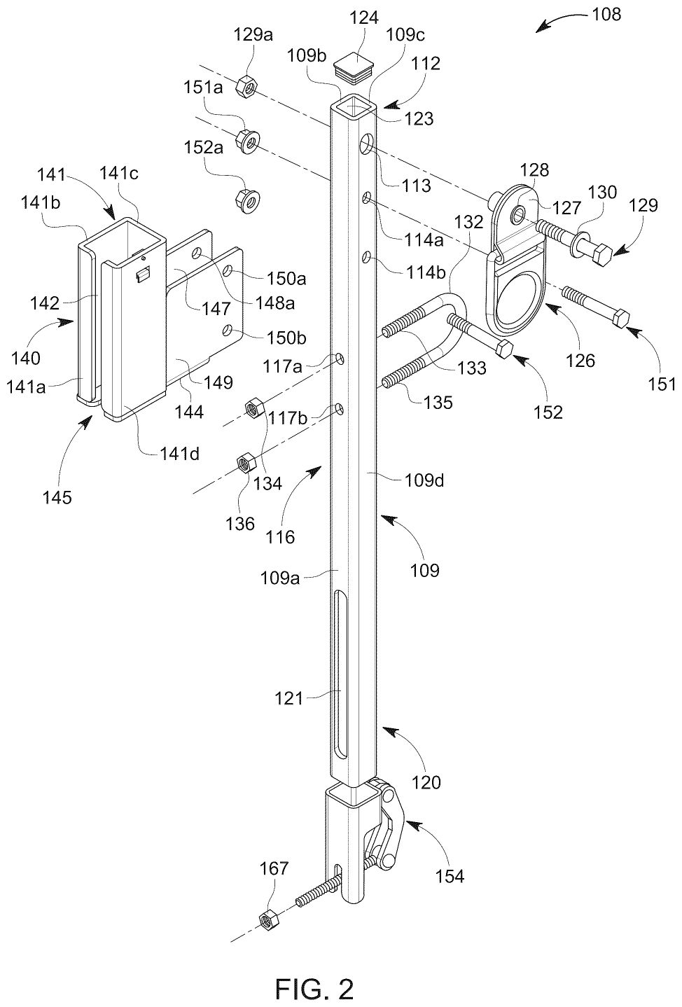

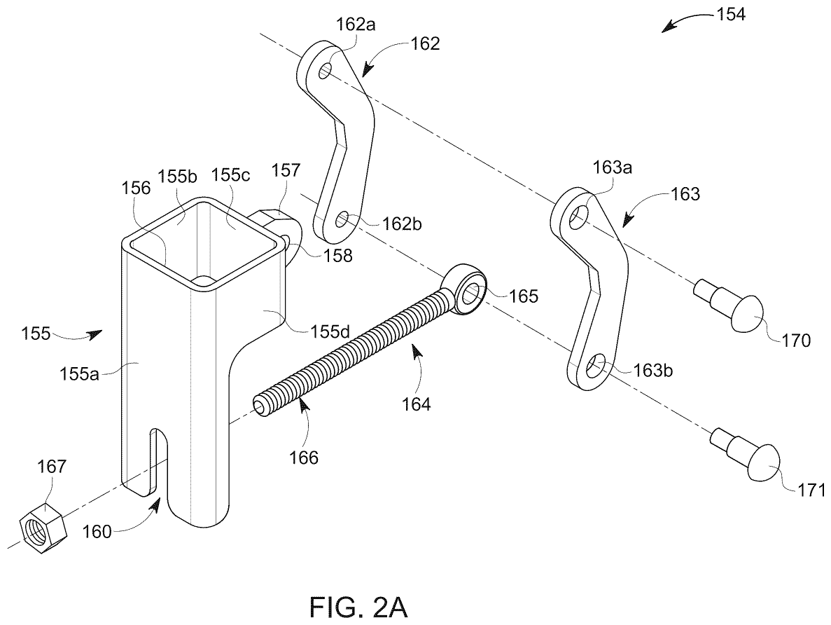

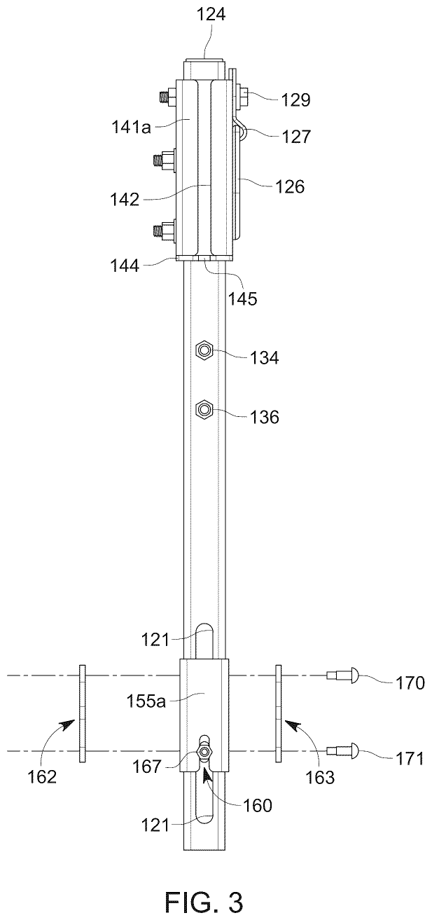

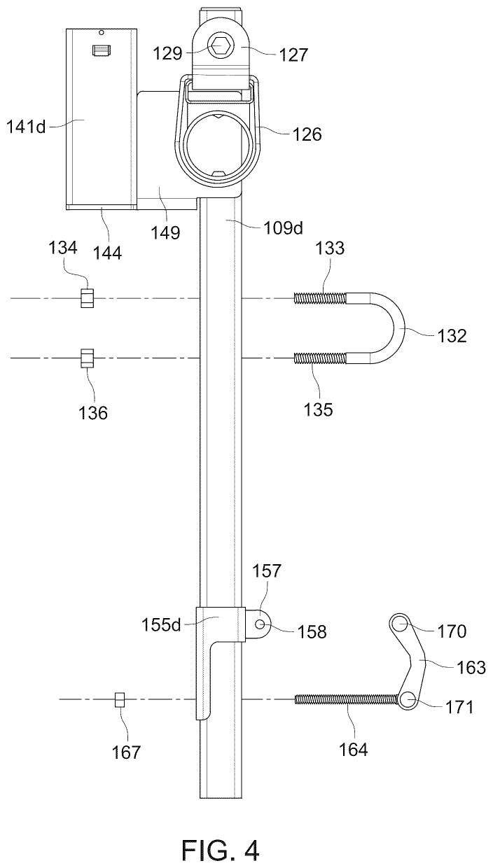

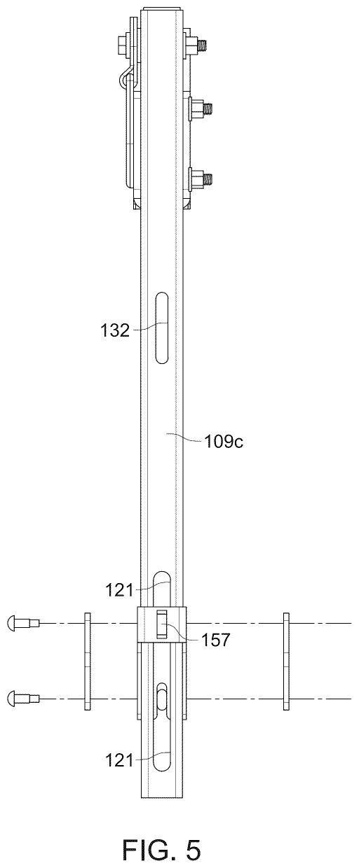

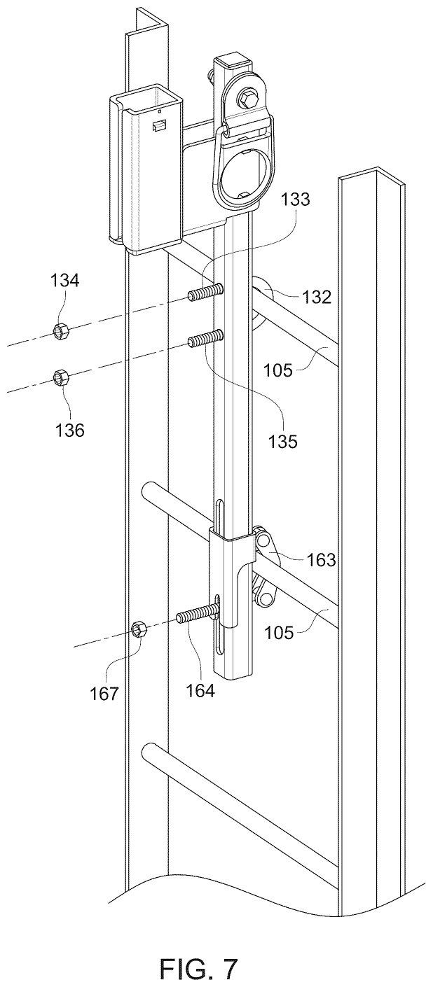

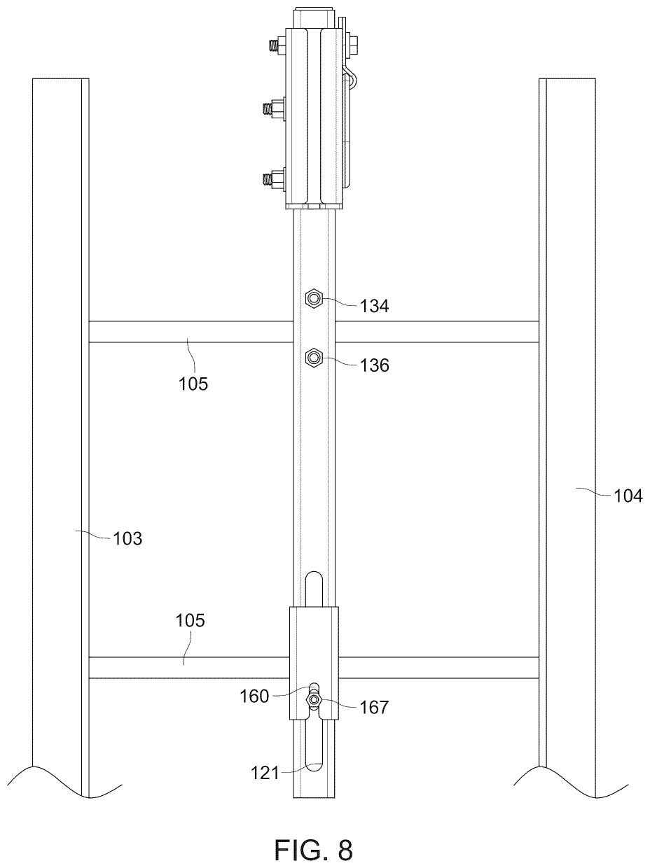

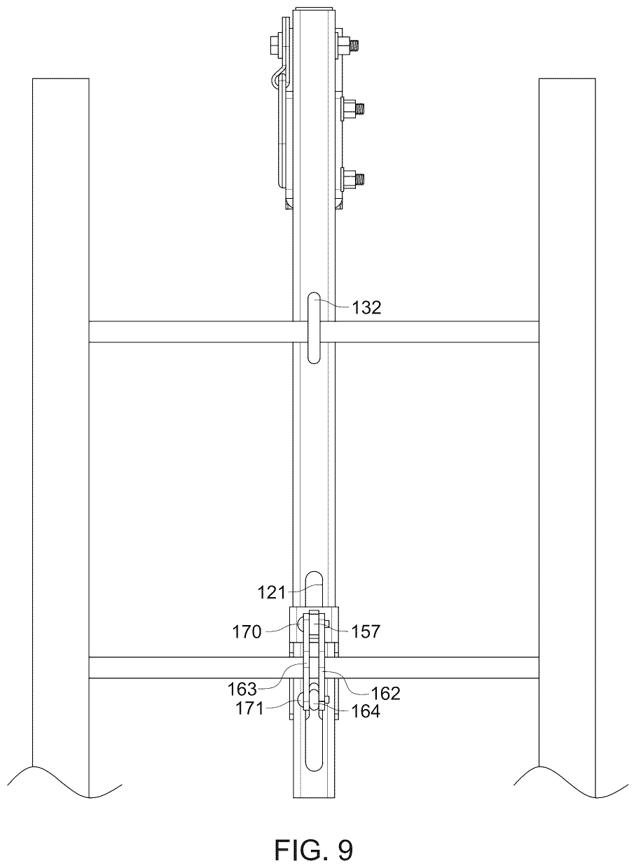

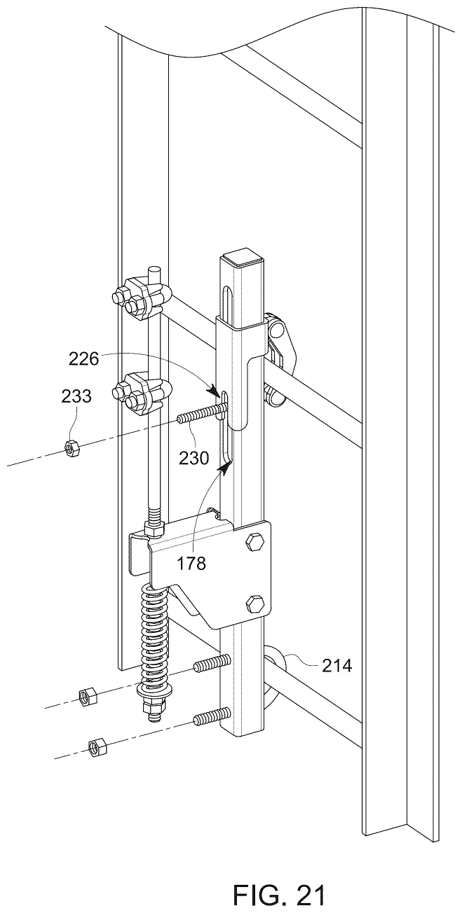

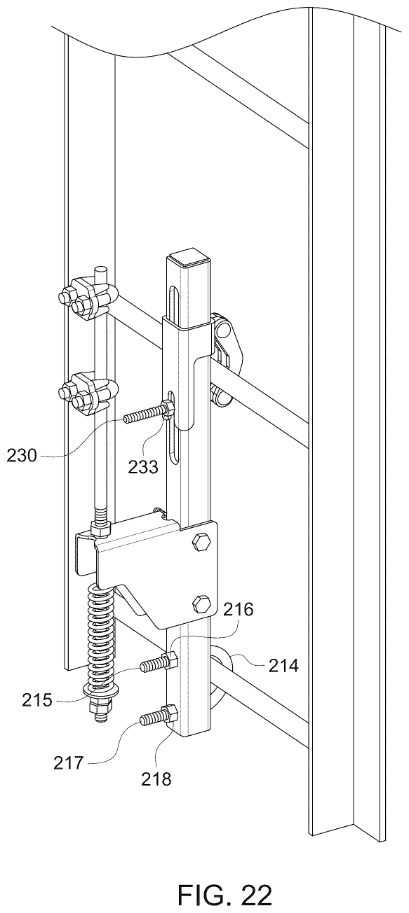

Embodiments of the disclosure generally provide a connector assembly for use with a ladder safety system. The connector assembly generally includes interconnected components for ease of installation and reducing the risk of losing or dropping individual components. In embodiments, the connector assembly connects one or both of top and bottom brackets to a support structure. In one embodiment, illustrated in FIGS. 2-9 and 19-24, a connector assembly 154, 220 is included in one or both of the top and bottom brackets 108 and 174.

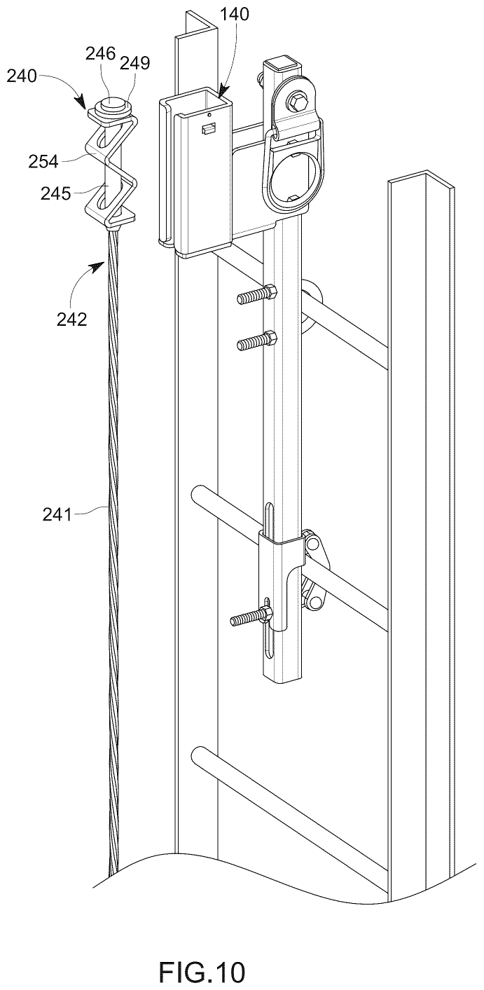

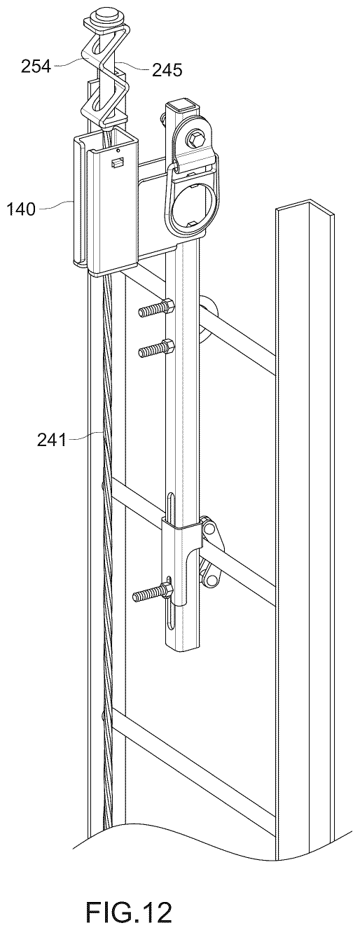

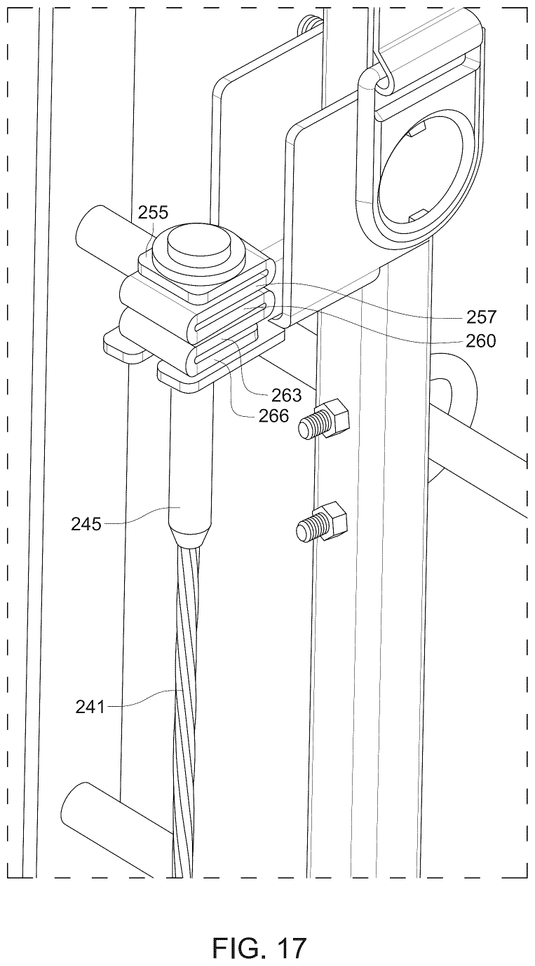

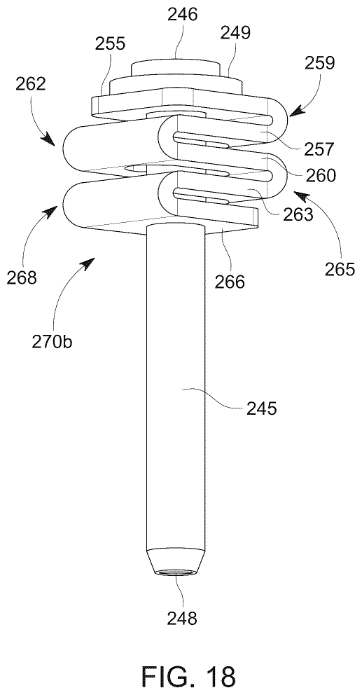

Embodiments of the disclosure generally provide an energy absorber assembly for use with a ladder safety system. The energy absorber is operatively connected to a cable of the ladder safety system for ease of installation and, should a fall occur, can act as a fall indicator. In one embodiment, illustrated in FIGS. 10-18, an energy absorber assembly 254 is preferably incorporated into the cable assembly 240 and housed within the top bracket 108.

In an example embodiment, the top bracket 108 includes a base 109, which is preferably an elongate tubular member having a first side 109a, a second side 109b, a third side 109c, and a fourth side 109d forming a cavity 123 extending longitudinally therethrough. A top 112 of the base 109 includes an aperture 113 extending through the second and fourth sides 109b and 109d, and apertures 114a and 114b extending through the second and fourth sides 109b and 109d are positioned below aperture 113. An intermediate portion 116 includes apertures 117a and 117b extending through the first and third sides 109a and 109c. A bottom 120 includes a slot 121 extending through the first and third sides 109a and 109c. Optionally, a cap 124 could be positioned on the top 112 of the base 109 to prevent access to the cavity 123.

A connector, such as a lifeline connector, is preferably operatively connected to the top 112 of the base 109 and includes a D-ring 126 pivotally operatively connected to a swivel connector plate 127. The swivel connector plate 127 is preferably a plate member folded onto itself to form a channel through which a base portion of the D-ring 126 extends, and the base can move within the channel thereby allowing the D-ring 126 to pivot relative to the swivel connector plate 127. The swivel connector plate 127 includes a bore 128 through which a bolt 129 extends. The bolt 129 extends through the aperture 113, and a nut 129a secures the bolt 129 thereto. An optional washer 130 can be positioned about the bolt 129 between the head of the bolt 129 and the swivel connector plate 127.

A U-shaped bolt 132 includes first and second ends 133 and 135 that are preferably threaded to operatively connect to nuts 134 and 136, respectively. The bolt 132 is configured and arranged so that a rung 105 can be positioned between the first and second ends 133 and 135, the first and second ends 133 and 135 are inserted through the apertures 117a and 117b, and then the nuts 134 and 136 are threaded onto the first and second ends 133 and 135, respectively, to secure the intermediate portion 116 of the top bracket 108 to the ladder 102.

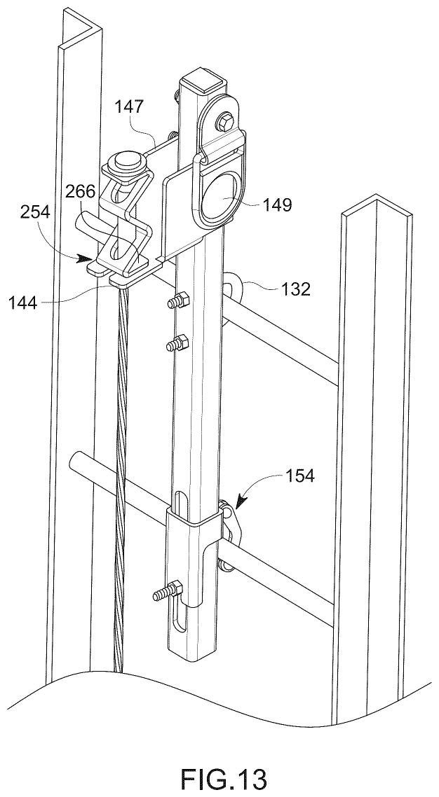

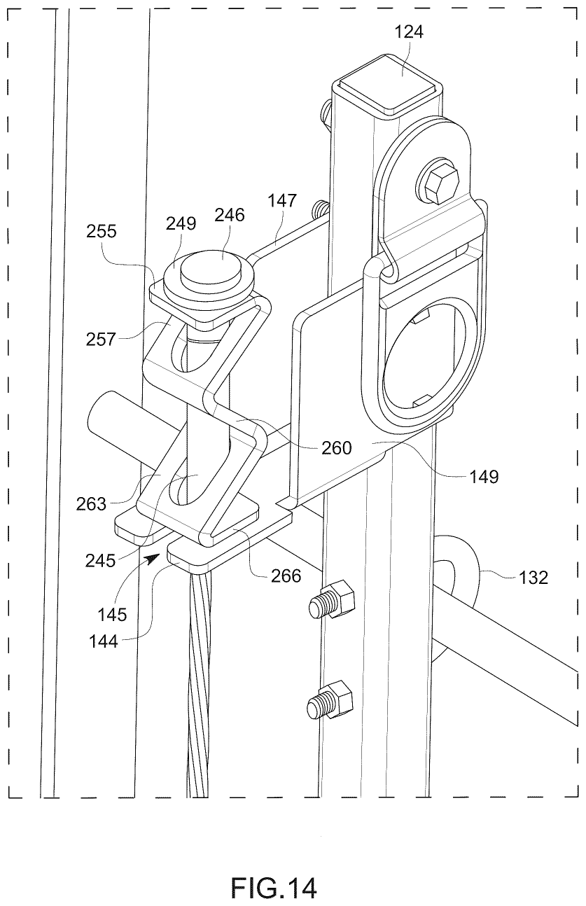

A housing 140 is operatively connected to the base 109, preferably between the swivel connector plate 127 and the bolt 132. The housing 140 includes a base 141, which is preferably an elongate tubular member having a first side 141a, a second side 141b, a third side 141c, and a fourth side 141d. A slot 142 extends longitudinally through the first side 141a. A bottom 144, shown in FIGS. 13 and 14, includes a front portion with a slot 145 perpendicularly aligned with the slot 142 of the base 141. A rear portion of the bottom 144 includes first and second side flanges 147 and 149 that extend upward and outward from opposing sides and are configured and arranged to receive a portion of the base 109 therebetween. The first side flange 147 includes an aperture 148a and an aperture (not shown) and the second side flange 149 includes an aperture 150a and an aperture 150b that align with the apertures in the first side flange, and the apertures in the flanges align with the apertures 114a and 114b in the base 109. A fastener 151 extends through apertures 148a, 114a, and 150a and a nut 151a secures the fastener 151 thereto. A fastener 152 extends through the aperture in the first side flange (not shown) and apertures 114b and 150b and a nut 152a secures the fastener 152 thereto.

A connector 154, shown in FIG. 2A, is slidably operatively connected to the bottom 120 of the base 109. The connector 154 includes a base 155, which is preferably a generally elongate tubular member having a first side 155a, a second side 155b, a third side 155c, and a fourth side 155d forming a bore 156 therebetween. The bore 156 is configured and arranged to slidably receive the base 109. An extension 157 with an aperture 158 extends outward from the third side 155c. The first side 155a includes a downward extension portion with a slot 160. A first arm 162 is generally curved and includes a bend between a first end having a first aperture 162a and a second end having a second aperture 162b, and a second arm 163 is generally curved and includes a bend between a first end having a first aperture 163a and a second end having a second aperture 163b. The first and second arms 162 and 163 are positioned on opposing sides of the extension 157 so that the apertures 162a, 158, and 163a align, and a fastener 170 extends therethrough to pivotally connect them. A fastener 164 includes a head with an aperture 165 and a threaded portion 166 extending from the head. The apertures 162b, 165, and 163b align, and a fastener 171 extends therethrough to pivotally connect them. The slot 160 is configured and arranged to selectively receive the threaded portion 166, and a nut 167 can be used to secure the threaded portion 166 in position relative to the first side 155a. The slot 160 selectively aligns with the slot 121 in the base 109 so that the threaded portion 166 extends through the slots 160 and 121 in an engaging position 173b. In a receiving position 173a, at least the fastener 164 is pivoted away from the base 155 so that a rung can be positioned between the base 155 and the arms 162 and 163.

The bottom bracket 174 includes a base 175, which is preferably an elongate tubular member having a first side 175a, a second side 175b, a third side 175c, and a fourth side 175d forming a bore 187 extending longitudinally therethrough. A top 177 of the base 175 includes a slot 178 extending through the first and third sides 175b and 175d. An intermediate portion 180 includes apertures 181a and 181b extending through the second and fourth sides 175b and 175d, and a bottom 184 includes apertures 185a and 185b extending through the first and third sides 175a and 175c. Optionally, a cap 188 could be positioned on the top 177 of the base 175 to prevent access to the bore 187.

In this example, a tension assembly 190 is operatively connected to the bottom bracket 174 with a tension bracket 191. The tension bracket 191 includes a top 192 having an aperture 193. A first side 194 having a first aperture 194a and a second aperture (not shown) and a second side 195 having a first aperture 195a and a second aperture 195b extend downward and outward from opposing sides of the top 192 and are configured and arranged to receive a portion of the base 175 therebetween. A fastener 196 extends through the apertures 194a, 181a, and 195a and a nut 196a secures the fastener 196 thereto, and a fastener 197 extends through the second aperture (not shown) in the first side 194 and the apertures 181b and 195b and a nut 197a secures the fastener 197 thereto, thereby securing the tension bracket 191 to the base 175.

The tension assembly 190 includes a bottom cable connector 200, which in this example is an elongate rod having a top portion 201 that is preferably not threaded and a bottom portion 203 with threading 204. It is recognized that the entire rod could be threaded. First and second connectors 202a and 202b are configured and arranged to receive a bottom portion 243 of cable 241 and secure the cable 241 to the rod. A nut 205 is positioned about a top of the bottom portion 203 to act as a stop, and the bottom portion 203 is inserted through the aperture 193 so that the bottom portion 203 extends downward from the top 192. A compression spring 208 is positioned about the rod and then a washer 209 and nuts 210 and 211 are positioned about a bottom of the bottom portion 203. With the compression spring 208 captured between the top 192 and the washer 209 and the nuts 205, 210, and 211 movable along the threading 204, the cable 241 can be tensioned as desired after installation.

A U-shaped bolt 214 includes first and second ends 215 and 217 that are preferably threaded to operatively connect to nuts 216 and 218, respectively. The bolt 214 is configured and arranged so that a rung 105 can be positioned between the first and second ends 215 and 217, the first and second ends 215 and 217 are inserted through the apertures 185a and 185b, and then the nuts 216 and 218 are threaded onto the first and second ends 215 and 217, respectively, to secure the bottom 184 of the bottom bracket 174 to the ladder 102.

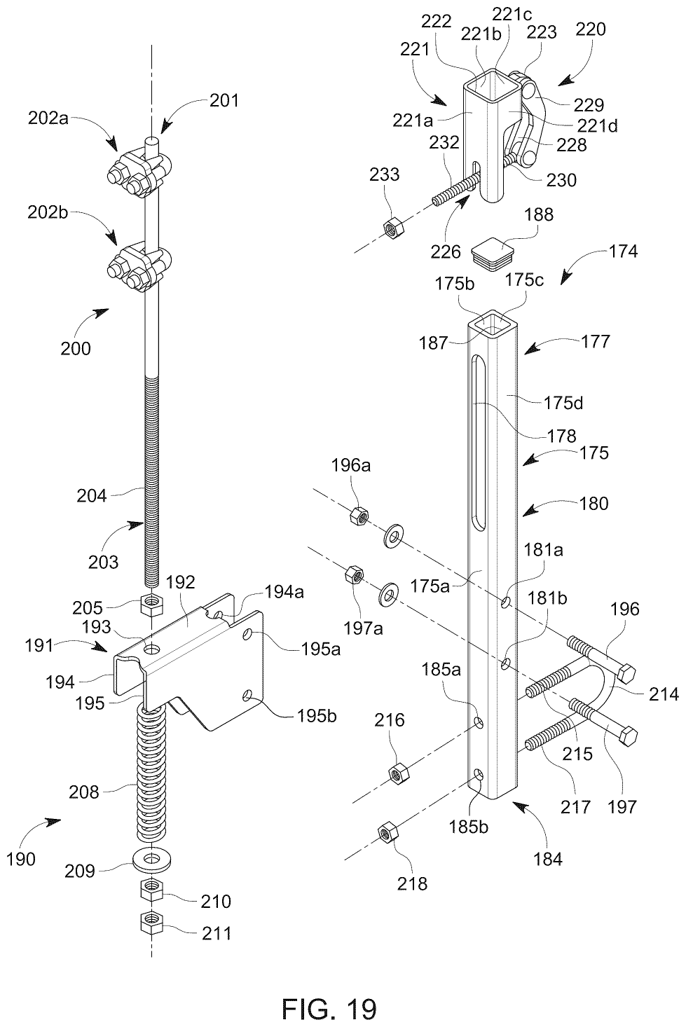

A connector 220, shown in FIG. 19, is slidably operatively connected to the top 177 of the base 175. In this example, the connector 220 is similar to connector 154. The connector 220 includes a base 221, which is preferably a generally elongate tubular member having a first side 221a, a second side 221b, a third side 221c, and a fourth side 221d forming a bore 222 therebetween. The bore 222 is configured and arranged to slidably receive the base 175. An extension 223 with an aperture (not shown) extends outward from the third side 221c. The first side 221a includes a downward extension portion with a slot 226. A first arm 228 is generally curved and includes a bend between a first end having a first aperture (not shown) and a second end having a second aperture (not shown), and a second arm 229 is generally curved and includes a bend between a first end having a first aperture (not shown) and a second end having a second aperture (not shown). The first and second arms 228 and 229 are positioned on opposing sides of the extension 223 so that the apertures align and a fastener 236 extends therethrough to pivotally connect them. A fastener 230 includes a head with an aperture (not shown) and a threaded portion 232 extending from the head. The apertures of the first and second arms and the fastener 230 align and a fastener 237 extends therethrough to pivotally connect them. The slot 226 is configured and arranged to selectively receive the threaded portion 232, and a nut 233 can be used to secure the threaded portion 232 in position relative to the first side 221a. The slot 226 selectively aligns with the slot 178 in the base 175 so that the threaded portion 232 extends through the slots 178 and 226 in an engaging position 239b. In a receiving position 239a, at least the fastener 230 is pivoted away from the base 221 so that a rung can be positioned between the base 221 and the arms 228 and 229.

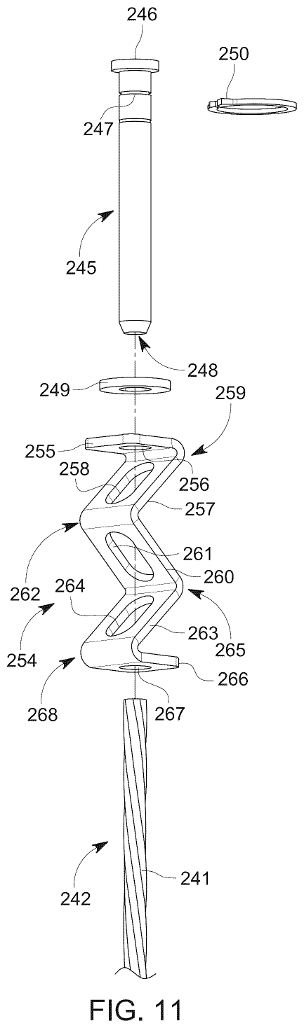

With the top and bottom bracket assemblies 108 and 174 operatively connected proximate the top and the bottom of the ladder 102, respectively, a cable assembly 240 can be operatively connected thereto. The cable 241 includes a top portion 242 and a bottom portion 243. The top portion 242 is operatively connected to a top cable connector 245, shown in FIG. 11. The top cable connector 245 is generally cylindrical forming a bore 248 configured and arranged to receive the top portion 242 of the cable. Preferably, the top cable connector 245 is swaged onto the top portion 242 but other suitable connections can be used. A flange 246 extends outward from a top of the connector 245 and the sides of the connector 245 include at least one annular groove 247 below the flange 246. A washer 249 is preferably positioned about the connector 245 proximate the flange 246, and a retainer 250 such as a spring clip is configured and arranged to engage the connector 245 within the groove 247.

An energy absorber 254 includes a generally rectangular piece of deformable material, preferably metal, bent in a zigzag configuration with apertures extending longitudinally therethrough. As shown in FIG. 11, the energy absorber 254 includes a top, first portion 255 with an aperture 256. A second portion 257 with an aperture 258 extends downward from the first portion 255 at an angle 259, a third portion 260 with an aperture 261 extends downward from the second portion 257 at an angle 262, a fourth portion 263 with aperture 264 extends downward from the third portion 260 at an angle 265, and a bottom, fifth portion 266 with an aperture 267 extends from the fourth portion 263 at an angle 268. Preferably, in one example, the first and fifth portions 255 and 266 are generally parallel and the second and fourth portions 257 and 263 zigzag at approximately 30 to 60 degrees (preferably approximately 45 degrees) from the first and fifth portions 255 and 266, respectively, while the third portion 260 zigzags at approximately 90 degrees from the second and fourth portions 257 and 263. Although an example embodiment is provided, it is recognized that any suitable angles could be used as long as the energy absorber is able to fold onto itself. The apertures 256, 258, 261, 264, and 267 are configured and arranged to receive the top cable connector 245. The first portion 255 is captured between the washer 249 and the retainer 250. The energy absorber assembly, including the top cable connector 245 and the energy absorber 254, is housed within the base 141 and the bottom 144 supports the energy absorber 254 with the top cable connector 245 selectively extending through the slot 145.

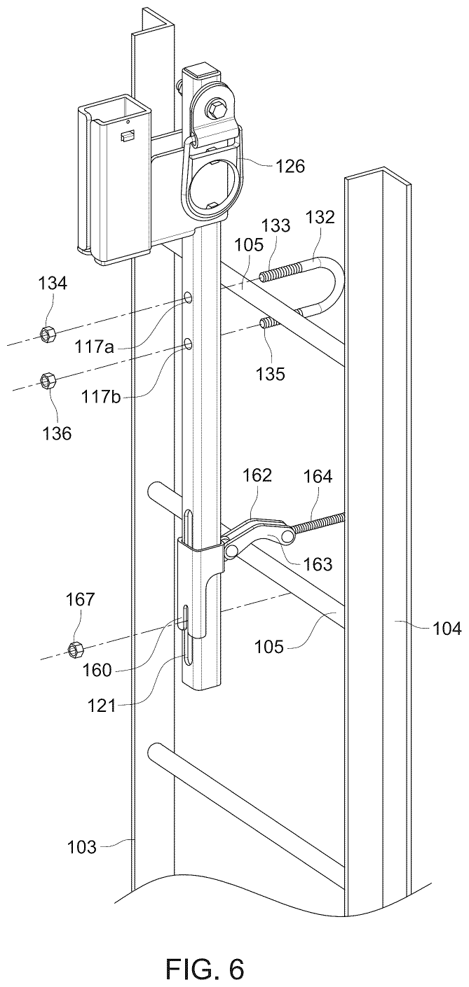

To install the ladder safety system 100, the top and bottom brackets 108 and 174 are connected to the ladder 102. Optionally, an intermediate support 272 is connected to the ladder 102 between the top and bottom brackets 108 and 174. To connect the top bracket 108 to the ladder 102, a top rung 105 of the ladder is positioned between the first and second ends 133 and 135 of the U-shaped bolt 132, the first and second ends 133 and 135 are inserted through the apertures 117a and 117b of the base 109, and then the nuts 134 and 136 are secured to the first and second ends 133 and 135. Preferably, the nuts 134 and 136 are not tightened until the connector 154 is also connected to a rung 105. The connector 154 is slid along the base 109 to align with a rung 105. The slot 121 in the base 109 provides adjustability for differing rung spacing. The first and second arms 162 and 163 of the connector 154 are pivoted upward thereby pivoting the fastener 164 upward so that the rung 105 can be positioned proximate the base 109 and then captured between the base 109 and the arms 162 and 163 when the arms 162 and 163 are pivoted downward. The fastener 164 is then pivoted to extend through the slot 121 in the base 109 and the slot 160 of the connector base 155. The nut 167 is then secured to the threaded portion 166 of the fastener 164. This is illustrated in FIGS. 6-9.

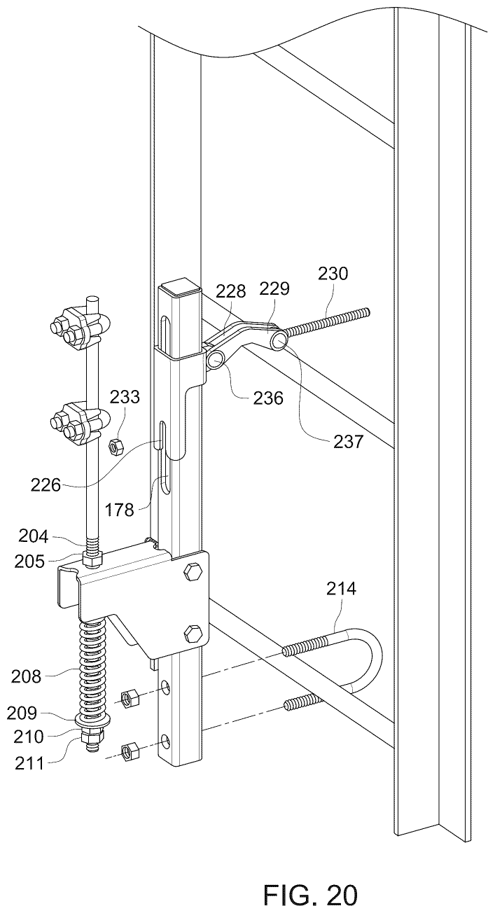

To connect the bottom bracket 174 to the ladder 102, a bottom rung 105 of the ladder is positioned between the first and second ends 215 and 217 of the U-shaped bolt 214, the first and second ends 215 and 217 are inserted through the apertures 185a and 185b of the base 175, and then the nuts 216 and 218 are secured to the first and second ends 215 and 217. Preferably, the nuts 216 and 218 are not tightened until the connector 220 is also connected to a rung 105. The connector 220 is slid along the base 175 to align with a rung 105. The slot 178 in the base 175 provides adjustability for differing rung spacing. The first and second arms 228 and 229 of the connector 220 are pivoted upward thereby pivoting the fastener 230 upward so that the rung 105 can be positioned proximate the base 175 and then captured between the base 175 and the arms 228 and 229 when the arms 228 and 229 are pivoted downward. The fastener 230 is then pivoted to extend through the slot 178 in the base 175 and the slot 226 of the connector base 221. The nut 233 is then secured to the threaded portion 232 of the fastener 230. This is illustrated in FIGS. 20-22.

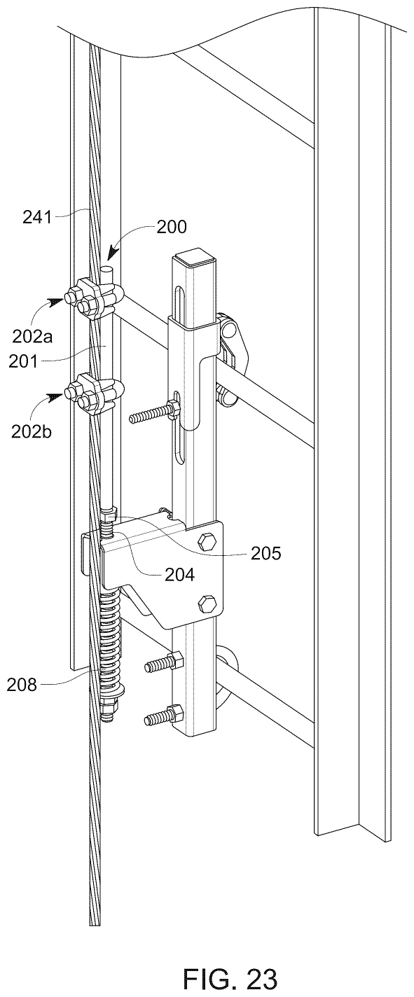

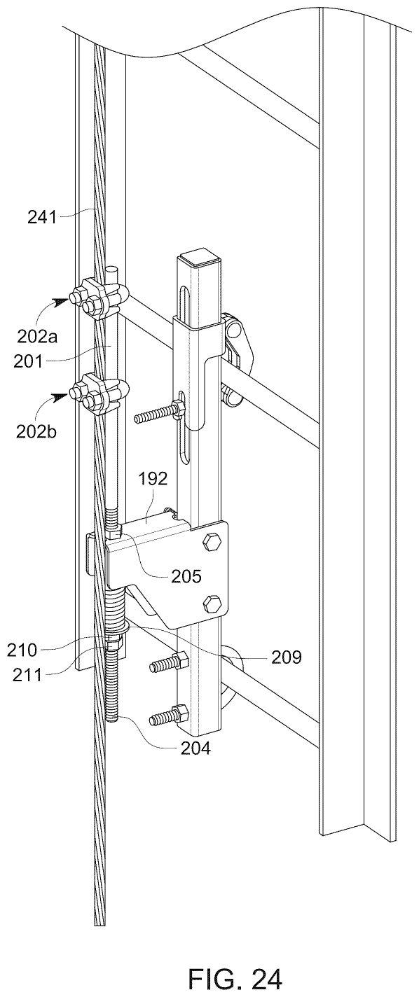

To connect the cable 241, preferably the top portion 242 is connected to the top cable connector 245 and the energy absorber 254, as previously described, and they are positioned within the housing base 141 so that the fifth portion 266 contacts the bottom 144 and the cable 241 extends downward through the slot 145. This is illustrated in FIGS. 10-14. The bottom portion 243 is then operatively connected to the bottom cable connector 200 by positioning the cable 241 between the top portion 201 and the first and second connectors 202a and 202b. The cable 241 is preferably pulled downward so that it is taut before the first and second connectors 202a and 202b are tightened to secure the cable 241 thereto. This is illustrated in FIGS. 23 and 24. The cable 241 is then tensioned by positioning the nuts 205, 210 and 211 closer together thereby compressing the spring 208 to the desired tension.

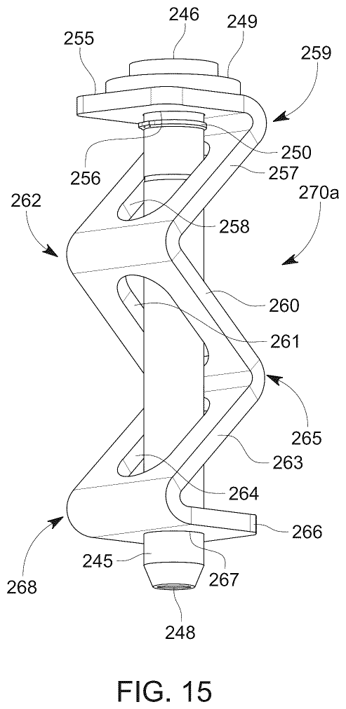

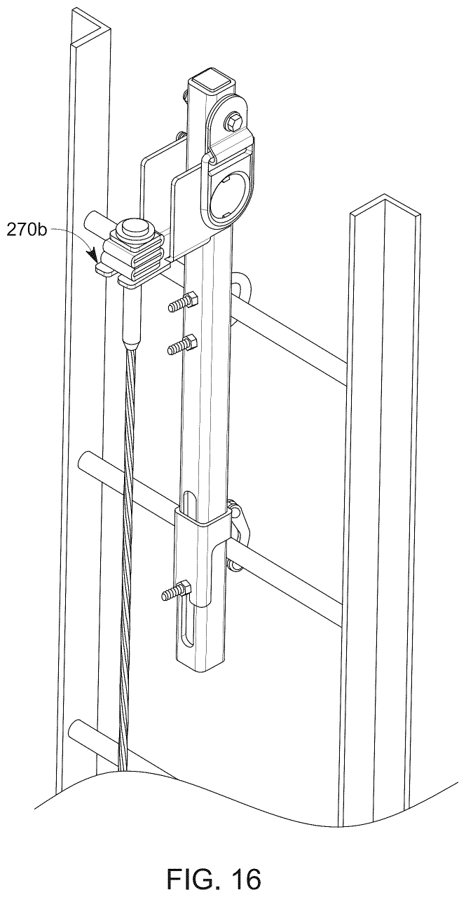

In use, a user connects to a cable sleeve 274, for example with a lanyard connected to a safety harness donned by the user, and the cable sleeve 274 is configured and arranged to move along the cable 241 as the user climbs or descends on the ladder 102. During normal use, the energy absorber 254 is in an expanded position 270a, shown in FIG. 15, with an intermediate portion of the cable connector positioned within the energy absorber. Should the cable 241 be subjected to a downward force, such as a fall with the cable sleeve 274 engaging the cable 241, the energy absorber 254 will deform or move toward a compressed position 270b, shown in FIGS. 16-18, with the intermediate portion of the cable connector extending downward from the energy absorber. It is recognized that the energy absorber 254 has positions between the expanded position 270a and the compressed position 270b. The deformation of the energy absorber 254 also provides indication that the cable has been subjected to a fall and should be inspected. The slot 142 allows for easy inspection of the energy absorber 254.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. An energy absorber assembly for use with a ladder safety system operatively connected to a ladder, comprising:
a cable connector configured and arranged to be operatively connected to a portion of a cable;
an energy absorber operatively connected to the cable connector and configured and arranged to move from an expanded position toward a compressed position; and
a bottom fixed relative to the ladder configured and arranged to support the energy absorber.

2. The energy absorber assembly of claim 1, wherein the cable connector includes a flange and a retainer, a first portion of the energy absorber being captured between the flange and the retainer.

3. The energy absorber assembly of claim 1, wherein the cable connector includes a bore configured and arranged to receive the portion of the cable, the cable connector being swaged onto the cable.

4. The energy absorber assembly of claim 1, wherein the energy absorber is made of metal.

5. The energy absorber assembly of claim 1, wherein the energy absorber includes a top portion, a bottom portion, and at least one intermediate portion interconnecting the top portion and the bottom portion.

6. The energy absorber assembly of claim 5, wherein the top portion is configured and arranged to contact the at least one intermediate portion and the at least one intermediate portion is configured and arranged to contact the bottom portion when the energy absorber is in the compressed position.

7. The energy absorber assembly of claim 5, wherein the top, at least one intermediate, and bottom portions include apertures through which the cable connector extends.

8. The energy absorber assembly of claim 5, wherein the top portion is a first portion, the at least one intermediate portion includes a second portion, a third portion, and a fourth portion, and the bottom portion is a fifth portion, wherein the first portion and the fifth portion are parallel and the second portion, third portion, and fourth portion zigzag between the first portion and the fifth portion.

9. The energy absorber assembly of claim 8, wherein the second portion is angled 30 to 60 degrees from the first portion and approximately 90 degrees from the third portion and the fourth portion is angled approximately 90 degrees from the third portion and 30 to 60 degrees from the fifth portion.

10. The energy absorber assembly of claim 1, wherein an intermediate connector portion of the cable connector is positioned within the energy absorber when the energy absorber is in the expanded position.

11. The energy absorber assembly of claim 1, wherein an intermediate connector portion of the cable connector extends downward from the energy absorber when the energy absorber is in the compressed position.

12. The energy absorber assembly of claim 1, wherein during use when a downward force is exerted on the cable the energy absorber moves from the expanded position toward the compressed position and an intermediate connector portion of the cable connector moves from being positioned within the energy absorber to extending downward from the energy absorber.

13. The energy absorber assembly of claim 1, wherein the bottom includes a bottom slot configured and arranged to selectively receive portions of the cable connector.

14. The energy absorber assembly of claim 1, wherein the energy absorber is contained within a housing to which the bottom is operatively connected, the housing being operatively connected to a bracket.

15. An energy absorber assembly for use with a ladder safety system operatively connected to a ladder, comprising:
a cable connector configured and arranged to be operatively connected to a portion of a cable;
an energy absorber operatively connected to the cable connector and configured and arranged to move from an expanded position toward a compressed position, the energy absorber including a top portion, a bottom portion, and at least one intermediate portion interconnecting the top portion and the bottom portion;
a bottom fixed relative to the ladder configured and arranged to support the bottom portion of the energy absorber; and
wherein during use, when a downward force is exerted on the cable, the energy absorber moves from the expanded position toward the compressed position and an intermediate connector portion of the cable connector moves from being positioned within the energy absorber to extending downward from the energy absorber, and wherein the top portion is configured and arranged to contact the at least one intermediate portion and the at least one intermediate portion is configured and arranged to contact the bottom portion when the energy absorber is in the compressed position.

16. The energy absorber assembly of claim 15, wherein the cable connector includes a bore configured and arranged to receive the portion of the cable, the cable connector being swaged onto the cable, and wherein the cable connector includes a flange and a retainer, a first portion of the energy absorber being captured between the flange and the retainer.

17. The energy absorber assembly of claim 15, wherein the top, at least one intermediate, and bottom portions include apertures through which the cable connector extends.

18. The energy absorber assembly of claim 15, wherein the top portion is a first portion, the at least one intermediate portion includes a second portion, a third portion, and a fourth portion, and the bottom portion is a fifth portion, wherein the first portion and the fifth portion are parallel and the second portion, third portion, and fourth portion zigzag between the first portion and the fifth portion.

19. The energy absorber assembly of claim 18, wherein the second portion is angled 30 to 60 degrees from the first portion and approximately 90 degrees from the third portion and the fourth portion is angled approximately 90 degrees from the third portion and 30 to 60 degrees from the fifth portion.

20. The energy absorber assembly of claim 15, wherein the energy absorber is contained within a housing to which the bottom is operatively connected, the housing being operatively connected to a bracket.
